(19) United States
(12) Patent Application Publication
(10) Pub. No.: US 2009/0196284 A1
(43) Pub. Date: Aug. 6, 2009

(54) Method for Providing an Emergency Call Service for VoIP Subscribers

(75) Inventor: Achim Beinroth, Berlin (DE)

Correspondence Address: LERNER GREENBERG STEMER LLP, P O BOX 2480, HOLLYWOOD, FL, 33022-2480, US

(73) Assignee: Nokia Siemens Networks GmbH & Co.KG, Munich (DE)

(21) Appl. No.: 12/306,879

(22) PCT Filed: May 2, 2005
(86) PCT No.: PCT/EP2007/054258

§ 371 Date: Dec. 29, 2008

(30) Foreign Application Priority Data
Jun. 28, 2006 (DE) 10 2006 029 716.4

(51) Int. Cl. H04L 12/66

(52) U.S. Cl. 370/352

(57) ABSTRACT

A requirement for an emergency call is to reach the nearest emergency call centre and to transmit information to said centre concerning the location of the caller. However, a pre-defined assignment of the subscriber number of the VoIP subscriber is not necessarily given, as a VoIP subscriber can use the telephone service from any Internet connection. To solve this problem, the emergency call service is implemented by the local VoIP service provider responsible in the roaming network of the VoIP subscriber.

### CLAIM FOR PRIORITY

This application is a national stage application of PCT/EP2007/054258, filed May 2, 2007, which claims the benefit of priority to German Application No. 102206029716.4, filed Jun. 28, 2006, the contents of which are hereby incorporated by reference.

### TECHNICAL FIELD OF THE INVENTION

The invention relates to a method for providing an emergency call server for VoIP subscribers.

### BACKGROUND OF THE INVENTION

In the case of an emergency call, it is necessary to access the closest and responsible emergency call center and to transmit thereto information about the location of the caller. This is already implemented in the landline network and in the mobile radio networks, and will soon be required for VoIP telephony. Since a VoIP subscriber can use the telephone service from any Internet connection, there is no longer necessarily a predefined association between the call number and a location. An additional problem results from the possibility of also using the VoIP service of the local/national provider when abroad. Even if the location of the subscriber at the time of the emergency call were known, the home VoIP service provider does not have the routing information in order to allow it to access all the emergency call centers worldwide.

A VoIP subscriber who at times is registered for the VoIP service at a different location than his home address will be referred to in the following text as a mobile VoIP subscriber (mobile in this context does not mean moving).

Source-dependent routing to the emergency call center is already possible for non-mobile VoIP subscribers. For this purpose, the subscriber data is statically linked in the softswitch to routing information in order to access the regionally responsible emergency call center. The call number is transmitted to the emergency call center, in order to locate the subscriber. There, the address of the subscriber can be determined, analogously to the emergency call service in the landline network, on the basis of a database query.

The described mechanisms currently do not operate for mobile VoIP subscribers since there is no fixed association between the subscriber call number and position information. At the moment, there is not yet any standardized solution for this problem.

### SUMMARY OF THE INVENTION

According to one embodiment of the invention, the emergency call service for a VoIP subscriber is provided by the service provider (SP) in the roaming network, and not by the home service provider of the VoIP subscriber.

An exemplary implementation of the invention follows. The local Internet service provider provides an SOS URI of a local emergency call server (of a local SIP service provider) which can pass on an emergency call to a national emergency call center. The local Internet service provider also provides position information relating to the physical Internet connection. The emergency call service is provided by a locally responsible VoIP service provider in the roaming network, even if the subscriber is still registered with his home service provider.

The ISP configures an SOS URI in its network, in the exemplary form SOS@localsipdomain, by means of which a national emergency call center can be accessed via a national/local VoIP service provider. By way of example, contractual relationships may exist for this purpose between an ISP and VoIP service provider, or a VoIP SP is appointed by a regulating authority.

The network is configured by the ISP (for example DSL provider or IT administration in the commercial network), such that the SOS URI is transmitted to connected VoIP clients (for example via DHCP).

The ISP still provides position information (for example in the form of geographic coordinates or a civilian address) which (for example by means of DHCP) is loaded to the VoIP client. An RFC (3825) already exists for transmission of geographic coordinates by means of DHCP. A DSL provider can in this case, for example, provide the address of the connection holder via the DSL port. In commercial networks, details can be provided about the location of the physical network port.

The VoIP client software receives and stores the position information and the SOS URI, and has a preconfigured list with emergency call numbers. It would likewise be feasible to dynamically add local emergency call numbers to the list. When an emergency call number is dialed, the dialed number is converted to the SOS URI.

The SIP INVITE message to set up a call is then sent to the local SIP service provider which is identified by the “localsipdomain” in the SOS URI. The INVITE message additionally contains the position information relating to the location of the emergency caller. Internet drafts already exist for the SIP upgrade required to do this.

The locally responsible VoIP service provider accepts the emergency call of the mobile VoIP client who is not registered with it, and passes it on to the responsible emergency call center on the basis of the position information that is also sent. A local VoIP SP has the necessary information on how to access an emergency call center in its responsibility area. The VoIP client is in this case still registered with its home service provider, where all “normal” calls are handled.

A VoIP service provider is used for the emergency calls in its responsibility area, irrespective of whether by its own registered VoIP clients or by roaming VoIP clients which are not registered with it.

### DETAILED DESCRIPTION OF THE INVENTION

The proposed concept for an emergency call service on the roaming network makes it possible to comply with the main requirements for an emergency call service for mobile VoIP subscribers (position-dependent routing and transmission of the subscriber location to the emergency call center) between different countries, provided that the physical network access is made in the country where the subscriber is currently located. Despite SIP registration with his home service provider, an emergency caller accesses a locally responsible emergency call center.

An exemplary emergency call scenario according to the invention is described below.

A VoIP subscriber registers for an SIP telephone service with his home VoIP service provider via an external Internet connection (abroad).

The VoIP client receives from the ISP of the external Internet connection the SOS URI (hosted by the VoIP SP in the roaming network) and the position information relating to the location of the network connection, and stores these internally.

The subscriber dials an emergency call.

The VoIP client identifies the emergency call number on the basis of a preconfigured list, and replaces this by the SOS URI in the form “SOS@localsipdomain”.

A call is set up to the SOS URI and the position information is also signaled.

This service provider, accessed using the SOS URI, accepts the emergency call from a non-registered client and carries out the further routing to the correct emergency call center in its responsibility area.

The received position information is used as information for routing. Furthermore, the position information is made available to the emergency call center. This is done either by direct signaling of the information or by access to a temporary database via the call number of the emergency caller as a key.

What is claimed is:

1. A method for providing an emergency call service for VoIP subscribers, comprising providing
the emergency call service by a locally responsible VoIP service provider in the roaming network of the VoIP subscriber.

2. A method for providing an emergency call service for VoIP subscribers, comprising:
loading, on registration of a VoIP subscriber, an address of an emergency call server of a local VoIP service provider and information relating to a physical Internet connection via which the registration is taking place, in a VoIP client of the VoIP subscribers;
placing a call the emergency call server, based on the address, when the VoIP client recognizes a received call number based on preconfigured list as an emergency call number, with the call including the position information; and
accepting the received call of the VoIP client by the emergency call server as an emergency call, and passing on to an emergency call center which is responsible for an area of the emergency call server.
